(19) United States
(12) Patent Application Publication
(10) Pub. No.: US 2026/0371354 A1
(43) Pub. Date: Nov. 19, 2026

(54) SYSTEMS, METHODS, AND NON-TRANSITORY PROCESSOR-READABLE MEDIA FOR FORWARDING SIGNALS

(71) Applicant: ZTE Corporation, Shenzhen (CN)

(72) Inventors: Hanqing XU, Shenzhen (CN); Nan ZHANG, Shenzhen (CN); Ziyang LI, Shenzhen (CN); Shuang ZHENG, Shenzhen (CN); Wei CAO, Shenzhen (CN)

(73) Assignee: ZTE Corporation, Shenzhen (CN)

(21) Appl. No.: 19/577,758

(22) Filed: Mar. 25, 2026

Related U.S. Application Data
(63) Continuation of application No. PCT/CN2023/122936, filed on Sep. 28, 2023.

(51) Int. Cl. H04W 72/231; H04L 27/26; H04W 72/0446

(52) U.S. Cl. CPC H04W 72/231; H04L 27/26025; H04W 72/0446

(57) ABSTRACT

Systems, methods, non-transitory processor-readable media, and apparatuses for receiving, by a first communication node from a controller, control information. The first communication node determines a reference time-domain resource based on at least one of a first time-domain resource or a first offset. The first communication node determines at least one second time-domain resource based on the reference time-domain resource. The first communication node forwards according to the control information using the at least one second time-domain resource, a signal received from a second communication node to a third communication node.

### CROSS-REFERENCE TO RELATED APPLICATION

This application claims the benefit of priority under 35 U.S.C. § 120 as a continuation of International Patent Application No. PCT/CN2023/122936, filed on Sep. 28, 2023, the disclosure of which is incorporated herein by reference in its entirety.

### TECHNICAL FIELD

The disclosure relates generally to wireless communications and, more particularly, to systems, methods, and non-transitory processor-readable media for forwarding signals.

### BACKGROUND

Although network deployment forms continue to change and evolve on the basis of traditional network deployment, coverage is a fundamental aspect of cellular network deployments. Mobile operators rely on different types of network nodes to offer blanket coverage in their respective deployments. Therefore, new types of network nodes have been considered to increase flexibility for network deployments.

### SUMMARY

In some arrangements, systems, methods, apparatuses, and non-transitory computer-readable media for receiving, by a first communication node from a controller, control information. The first communication node determines a reference time-domain resource based on at least one of a first time-domain resource or a first offset. The first communication node determines at least one second time-domain resource based on the reference time-domain resource. The first communication node forwards according to the control information using the at least one second time-domain resource, a signal received from a second communication node to a third communication node.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 is a diagram illustrating an example cellular communication system, in accordance with some arrangements.

FIG. 2 is a block diagram illustrating examples of a BS, a UE, and an SN, in accordance with some arrangements.

FIG. 3 is a block diagram illustrating transmission links between the BS and the SN and between the SN and the UE, according to various arrangements.

FIG. 4 is a diagram illustrating an example of aperiodic or dynamic control information indication, according to various arrangements.

FIG. 5 is a flowchart diagram illustrating an example method for managing forwarding signals by an SN, according to various arrangements.

FIG. 6 is a diagram illustrating an example time-domain structure for CU channel SCS of 15 kHz and FU reference SCS of 35 kHz, according to various arrangements.

FIG. 7 is a diagram illustrating an example time-domain structure for CU channel SCS of 15 kHz and FU reference SCS of 120 kHz, according to various arrangements.

FIG. 8 is a diagram illustrating an example time-domain structure for CU channel SCS of 30 kHz and FU reference SCS of 15 kHz, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

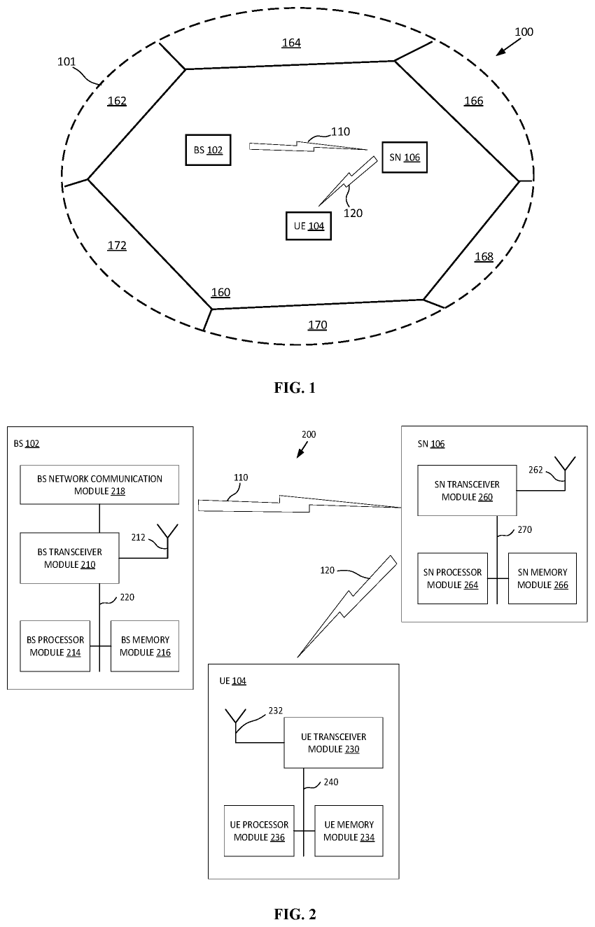

FIG. 1 illustrates an example wireless communication system 100, in accordance with an arrangement of the present disclosure. The wireless communication system 100 can be used to implement a wireless network, such as a cellular network or a narrowband network. The system 100 includes a BS 102, a UE 104, and a Smart Node (SN) 106.

As used herein, an SN is a network node that supports a controllable amplify-and-forward operation or a forward operation of wireless signals. Examples of the SN include a repeater (e.g., a Network-Controlled Repeater (NCR), UE-controlled repeater, a smart repeater, and so on), a relay node, a Re-configuration Intelligent Surface (RIS), an Intelligent Reflecting Surface (IRS), an Integrated Access and Backhaul (IAB) node, a portion or part of a Base Station (BS), a Transmission and Reception Point (TRP), a User Equipment (UE), a wireless communication device, and so on. As used herein, a forward operation by the SN can refer to one or more of receiving signals, transmitting signals, or receiving and transmitting signals.

For example, an IAB node is type of network node that does not require a wired backhaul. Radio Frequency (RF) repeater is another type of network node which performs an amplify-and-forward operation for any signal that it receives. RF repeaters have seen a wide range of deployments in 2G, 3G and 4G to supplement the coverage provided by regular full-stack cells. RF repeater has only a radio unit.

An NCR is an enhancement over conventional RF repeaters given that an NCR has the capability to receive and process side control information from the network. Side control information allows an NCR to perform an amplify-and-forward operation more efficiently. Thus, the NCR mitigates necessary noise amplification, transmissions, and receptions with better spatial directivity and provides simplified network integration. The mechanism disclosed herein can be likewise implemented for other systems such as for RIS, and so on.

The BS 102 and the UE 104 can communicate with each other indirectly via the SN 106. For example, the BS 102 can communicate with (e.g., send data, signals, messages, and information to and receive data, signals message, and information from) the SN 106 via a first communication link 110 (e.g., a first wireless communication channel), vice versa. The SN 106 can communicate with (e.g., send data, signals, messages, and information to and receive data, signals message, and information from) the UE 104 via a second communication link 120 (e.g., a second wireless communication channel), vice versa. The SN 106 can forward the signals received from the BS 102 via the first communication link 110 to the UE 104 via the second communication link 120, in some examples. In some examples, the SN 106 can amplify and forward the signals received from the BS 102 via the first communication link 110 to the UE 104 via the second communication link 120. Accordingly, the SN 106 can extend the coverage of the BS 102.

As shown, the system 100 can provide wireless communication services for a cluster of cells, e.g., at least 160, 162, 164, 166, 168, 170, and 172 overlaying a geographical area 101. At least one BS is locate within each of the cells 160, 162, 164, 166, 168, 170, and 172 and operates at a bandwidth to provide radio coverage and wireless communication services to users (e.g., UEs) within that cell. For example, the BS 102 can operate at a channel transmission bandwidth to provide radio coverage and wireless communication services to UEs within the cell 160, in which the BS 102 is located. Although the UE 104 is shown to be within the cell 160, the BS 102 can communicate indirectly with the UE 104 via the SN 106, so that the UE 104 may or may not be within the cell 160, as long as the UE 104 is within a service area of the SN 106. In other words, as long as the SN 106 is within the cell 160, and the UE 104 is within a service area of the SN 106, the BS 102 can communicate with the UE 104 indirectly via the SN 106.

In some arrangements, the BS 102 communicates with the SN 106, vice versa, via a radio frame structure including time-domain units such as frames. The SN 106 communicates with the UE 104, vice versa, via a radio frame structure including time-domain units such as frames. Each frame can be further divided into subdivisions such as subframes and/or slots. Each slots may include multiple data symbols. In the present disclosure, the BS 102, the UE 104, and the SN 106 are described herein as non-limiting examples of communication nodes or network nodes which can practice the methods disclosed herein. Such communication nodes can be capable of wireless and/or wired communications, in accordance with various arrangements of the present solution.

FIG. 2 is a block diagram illustrating examples of the BS 102, the UE 104, and the SN 106, in accordance with some arrangements. The BS 102 includes a BS transceiver module 210, a BS antenna 212, a BS processor module 214, a BS memory module 216, and a BS network communication module 218, each module being coupled and interconnected with one another as necessary via a BS data communication bus 220. The SN 106 includes a SN transceiver module 260, a SN antenna 262, a SN processor module 264, and a SN memory module 266, each module being coupled and interconnected with one another as necessary via a SN data communication bus 270. The UE 104 includes a UE transceiver module 230, a UE antenna 232, a UE memory module 234, and a UE processor module 236, each module being coupled and interconnected with one another as necessary via a UE data communication bus 240.

The BS 102 communicates with the SN 106 via the first communication channel 110 (e.g., a first wireless transmission link, a first wireless data transmission link, etc.), which can be any wireless channel or other medium suitable for transmission of data as described herein. The SN 106 communicates with the UE 104 via the second communication channel 120 (e.g., a second wireless transmission link, a second wireless data transmission link, etc.), which can be any wireless channel or other medium suitable for transmission of data as described herein.

Each of the BS 102, the SN 106, and the UE 104 can further include any number of modules other than the modules shown in FIG. 2. The various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some arrangements, the BS transceiver module 210 includes a Radio Frequency (RF) transmitter and a RF receiver, each including circuitry that is coupled to the BS antenna 212. A duplex switch (not shown) can alternatively couple the transmitter or receiver to the antenna in time duplex fashion. The UE transceiver module 230 includes a RF transmitter and a RF receiver, each including circuitry that is coupled to the UE antenna 232. A duplex switch (not shown) can alternatively couple the transmitter or receiver to the antenna in time duplex fashion. The SN transceiver module 260 includes a RF transmitter and a RF receiver, each including circuitry that is coupled to the SN antenna 262. A duplex switch (not shown) can alternatively couple the transmitter or receiver to the antenna in time duplex fashion.

The BS transceiver module 210 and the SN transceiver module 260 are configured to communicate via the first communication link 110 and cooperate with a suitably configured RF antenna arrangement that can support a particular wireless communication protocol and modulation scheme. The UE transceiver module 230 and the SN transceiver module 260 are configured to communicate via the second communication link 120 and cooperate with a suitably configured RF antenna arrangement that can support a particular wireless communication protocol and modulation scheme.

In some illustrative arrangements, the BS transceiver module 210, the UE transceiver module 230, and the SN transceiver module 260 are configured to support industry standards such as the Long Term Evolution (LTE), 5G standards, 6G standards, and the like. It is understood, however, that the present disclosure is not necessarily limited in application to a particular standard and associated protocols. Rather, the BS transceiver module 210, the UE transceiver module 230, and the SN transceiver module 260 can be configured to support alternate, or additional, wireless data communication protocols, including future standards or variations thereof.

In some arrangements, the UE 104 may be embodied in various types of user devices such as a mobile phone, a smart phone, a Personal Digital Assistant (PDA), tablet, laptop computer, wearable computing device, a vehicle, and so on. In some arrangements, the BS 102 can include a gNB, evolved node B (eNB), a serving eNB, a serving gNB, and so on.

The processor modules 214, 236, and 264 can be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the arrangements disclosed herein may be embodied directly in hardware, in firmware, in a software module executed by processor modules 214, 236, and 264, respectively, or in any practical combination thereof. The memory modules 216, 234, and 266 may be realized as RAM memory, flash memory, ROM memory, EPROM memory, EEPROM memory, registers, a hard disk, a removable disk, a CD-ROM, or any other form of storage medium known in the art. In this regard, memory modules 216, 234, and 266 may be coupled to the processor modules 214, 236, and 264, respectively, such that the processors modules 214, 236, and 264 can read information from, and write information to, memory modules 216, 234, and 266, respectively. The memory modules 216, 234, and 266 may also be integrated into their respective processor modules 214, 236, and 264. In some arrangements, the memory modules 216, 234, and 266 can each include a cache memory for storing temporary variables or other intermediate information during execution of instructions to be executed by processor modules 214, 236, and 264, respectively. Memory modules 216, 234, and 266 can also each include non-volatile memory for storing instructions to be executed by the processor modules 214, 236, and 264, respectively.

The BS network communication module 218 generally represents the hardware, software, firmware, processing logic, and/or other components of the BS 102 that enable bi-directional communication between BS transceiver module 210 and other network components and communication nodes configured to communication with the BS 102, such as the core network. For example, the BS network communication module 218 may be configured to support internet or WiMAX traffic. In a typical deployment, without limitation, the BS network communication module 218 provides an 802.3 Ethernet interface such that BS transceiver module 210 can communicate with a conventional Ethernet based computer network. In this manner, the BS network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

In some examples, the CU and the FU can be separate and/or dedicated components or hardware of an SN (e.g., separate SN processor modules 264 and SN memory modules 266). In some examples, the CU and the FU can be different logics or algorithms running on a same component or hardware of the SN (e.g., the same SN processor module 264 and the SN memory module 266). In some examples, the SN can include an interface to enable information exchange/transition between the CU and the FU.

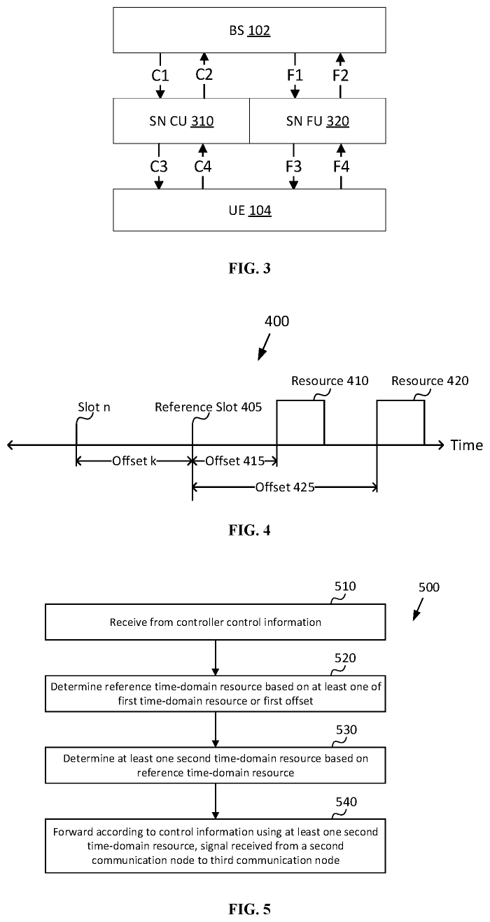

FIG. 3 is a block diagram illustrating transmission links between the BS 102 and the SN 106 and between the SN 106 and the UE 104, according to various arrangements. In some arrangements, the SN 106 can include a first functional unit to receive and decode side control information from a controller (e.g., a BS, a UE, or another third-party entity). Examples of the first functional unit include a Control/Communication Unit (CU), a Mobile Termination (MT) unit, a part or a functional unit of UE, a third-party IoT device, and so on. CU 310 is used to generally refer to various examples of the first functional unit. The CU 310 can be implemented using a combination of the SN processor module 264 and the SN memory module 266.

In some arrangements, the SN 106 can include a second functional unit to carry out the amplify-and-forward operation or the forward operation of wireless signals received according to the side control information received by the SN. Examples of the second functional unit include a Forwarding Unit (FU or Fwd), a Radio Unit (RU), a Distributed Unit (DU), a part or a functional unit of UE, a part of a functional unit of an RIS, and so on. FU 320 is used to generally refer to various examples of the second functional unit. The FU 320 can be implemented using a combination of the SN processor module 264 and the SN memory module 266.

Control links between the BS 102 and the CU 310 include links C1 and C2, over the first communication link 110. Control links between the CU 310 and the UE 104 include links C3 and C4, over the second communication link 120. Forwarding links between the BS 102 and the FU 320 include links F1 and F2, over the first communication link 110. Forwarding links between the FU 320 and the UE 104 include links F3 and F4, over the second communication link 120.

In some examples, links C1 and C4 are control links (or C-links) from a controller (e.g., the BS 102 or the UE 104) to the CU 310. The links C2 and C3 are C-links from the CU 130 to a controller. F1 is a forwarding link (F-link) from the BS 102 to the FU 320. F2 is a F-link from the FU 320 to the BS 102. F3 is a forwarding link from the FU 320 to the UE 104. F4 is a forwarding link from the UE 104 to the FU 320.

Signals from the BS 102 to the FU 320 via F-link F1 and signals from the UE 104 to the FU 320 via F-link F4 is unknown by the FU 320. The FU 320 simply forwards or amplifies and forwards those signals without decoding the same. The links F1 and F2 are also referred to as backhaul links (B-links). The links F3 and F4 are also referred to as access links (A-links). A B-link and an A-links are parts of the F-link, and the combination of the two constitutes a complete F-link. For example, the combination of the links F1 and F3 is the complete DL F-link from the BS 102 to the UE 104, in which F3 is the SN FU DL F-link. The combination of the links F2 and F4 is the complete UL F-link from the UE 104 to the BS 102, in which F2 is the SN FU UL F-link.

In a C-link, the signal from a sender will be detected and decoded by the receiver, so that the information transmitting in the C-link can be utilized to control the status of a F-link. For example, signals from the BS 102 to the CU 310 via C-link C1 and signals from the UE 104 to the CU 310 via C-link C4 are detected, decoded, and processed by the CU 310, to control the F-links.

The CU 310 can receive side control information from the controller (e.g., via at least one of the links C1 and C4) to control the amplify-and-forward operation or the forward operation of the FU 302. Examples of the side control information include Downlink Control Information (DCI), Uplink Control Information (UCI), Sidelink (or Side) Control Information (SCI), and so on. After receiving side control information, a certain time delay is needed for the SN 106 to decode the side control information, to perform beam switching, and/or perform inter-module operation.

The CU 310 uses a first numerology, first Subcarrier Spacing (SCS), and a first Cyclic Prefix (CP) for its transmissions such as Physical Downlink Control Channels (PDCCH), Physical Uplink Control Channel, and so on. The FU 320 uses a second numerology (e.g., a reference numerology), second SCS (e.g., a reference SCS), and a second CP (e.g., a reference CP) for its forwarding operations. In some examples, the first numerology is different from the second numerology. In some examples, the first SCS is different from the second SCS. In some examples, the first CP is different from the second CP. The arrangements disclosed herein relate to determining when does the SN start applying side control information is a problem that needs to be addressed.

In some arrangements, a reference slot is determined for each time-domain resource configured for a forwarding operation for the FU 320. In some arrangements, slot n can be defined as a slot used for a channel reception or a slot that overlaps with an end of the channel reception. In some arrangements, offset k can be defined based on capability of the CU 310, can be declared by vendors, or indicated by the controller, or can be a pre-defined value.

FIG. 4 is a diagram illustrating an example of aperiodic or dynamic control information indication 400, according to various arrangements. FIG. 4 illustrates an application time for the indicated control information in the examples in which the numerology of channels of the CU 310 and the reference numerology are the same. While slots n and reference slot 405 are shown as a line along the time-domain, one of ordinary skill in the art can recognize that the slot n and reference slot 405 can have any suitable duration in the time-domain.

In aperiodic or dynamic control information indication 400, a reference time-domain resource such as the reference slot 405 for each time-domain resource 410 or 420 is defined as the slot n+k. In some examples, slot n refers to the slot in which the CU 310 receives the side control information (e.g., one or more of the DCI, UCI, or SCI) carrying the indication from a controller. In some examples, k is an offset value. The value of offset k reflects the delay for decoding the side control information, beam switching and/or inter-module operation. The offset k can be defined as SN CU capability, declared by vendors, indicated by the controller, and/or is a pre-defined value. For example, the BS 102 can configure the offset k to the CU 310 via suitable signaling including Radio Resource Control (RRC) signaling, DCI signaling, or so on. For example, the UE 104 can configure the offset k to the CU 310 via suitable signaling. In the examples in which offset k is defined as SN CU capability, the CU 310 can report the offset k to the controller.

The locations of the resource 410 and the resource 420 in the time domain can be determined using the reference slot 405. For example, a start of the resource 410 is offset from the reference slot 405 by the offset 415. A start of the resource 420 is offset from the reference slot 405 by the offset 425. In some examples, the offset k is different from the parameter used to define the slot offsets (e.g., slot offset 415 for resource 410 and slot offset 420 for resource 420) for the resources 410 and 420. The FU 320 can receive data, signal, message, and information from the BS 102 (via F1) or the UE 104 (via F4) in one or more of the resources 410 and 420. The FU 320 can forward or amplify and forward data, signal, message, and information to the BS 102 (via F2) or the UE 104 (via F3) in one or more of the resources 410 and 420.

In some examples in which the numerology of channels of the CU 310 (e.g., PDCCH, a Physical Uplink Control Channel (PUCCH), and so on) is the same as the reference numerology in an aperiodic configuration configured for the forward operation of the FU 320 (e.g., for time-domain resources in an access link), mechanism for determining the application time of the indicated control information as illustrated in FIG. 4 can be implemented.

In some examples, the channels of the CU 310 have numerology different from the reference numerology in an aperiodic configuration configured for the forward operation of the FU 320, especially in out-of-band operation mode. In such examples, the application time (e.g., the reference slot 405) for the time-domain resources configured for the forward operations of the FU 320 can be determined using various arrangements disclosed herein.

In some examples, slot n includes at least one slot used by the CU 310 for channel reception (e.g., receiving a channel). In some examples, slot n is a slot that overlaps with an end portion of a channel reception. A slot that overlaps with the end of a channel reception is a time-domain resource (e.g., a slot) in which the last symbol of a channel is located. In some examples, the numerology of slot n can refer to the numerology of the channel (or an active Bandwidth Part (BWP) of the CU 310) received by the CU 310. In some examples, the numerology of slot n can refer to the reference numerology in an aperiodic configuration configured for the forward operation of the FU 320.

In some examples, examples of the channel received by the CU 310 in slot n can include at least one of a PDCCH, a Physical Downlink Shared Channel (PDSCH), a PUCCH, a Physical Uplink Shared Channel (PUSCH), a Physical Sidelink Shared Channel (PSSCH), a Physical Sidelink Control Channel (PSCCH), Physical Sidelink Feedback Channel (PSFCH), and so on. Although PDCCH is referred to throughout the disclosure as an example of the channel, other types of channel can be likewise implemented. In some examples, the channel provides or contains indication such as one or more of the DCI, UCI, or SCI to indicate the side control information for the forward operation of the FU 320. For example, the side control information includes information of one or more of at least one beam or a time-domain resource in an access link used to forward or amplify and forward signals received from the BS 102 to the UE 104. For example, the side control information includes information of one or more of at least one beam or a time-domain resource in an access link used to forward or amplify and forward signals received from the UE 104 to the BS 102.

In some arrangements, offset k can be defined based on capability of the CU 310, declared by vendors, and/or indicated by the controller, or pre-defined with a value. In some examples, the value of offset k is determined based on the numerology of the channel or an active BWP of the CU 310. In some examples, the value of offset k is determined based on the reference numerology. The value of offset k reflects the delay of decoding the indication, beam switching and/or inter-module operation. In the examples in which offset k is defined as SN CU capability, offset k can be reported by the SN (e.g., the CU 310) to the controller. The unit of offset k can be a symbol, slot, subframe, frame, second, millisecond, microsecond, etc. For ease of description, this document takes “slot” as an example.

In some arrangements, both a numerology of slot n and offset k refer to a reference numerology. The reference slot 405 for each time-domain resource 410 and 420 of the forward and amplify-and-forward operation of the FU 320 can be defined as the slot n+k. In some examples, the reference slot 405 is a slot that is after at least one slot (e.g., slot n) in which channel providing the side control indication (e.g., carried in one or more of the DCI, UCI, or SCI) is received by a number of slots corresponding to or defined by the offset k. That is, the reference slot 405 is a number of slots (indicated or corresponding to the offset k) after the at least one slot in which the side control indication is received. In some examples, the reference slot 405 is a slot that is offset by a number of slots indicated by or corresponding to offset k from at least one slot (e.g., slot n) in which channel providing the side control indication (e.g., carried in one or more of the DCI, UCI, or SCI) is received. That is, the reference slot 405 is offset with respect to the at least one slot (e.g., slot n) in which channel providing the side control indication by a number of slots defined by offset k.

In some examples, the indication carried by the one or more of the DCI, UCI, or SCI is used to indicate the control information (e.g., the information of beam or time-domain resource in access link) for forward operation of the FU 320. In some examples in which the reference slot 405 is used as the reference for the time-domain resources 410 and 420 configured for the forward operation of the FU 320, the numerology of reference slot 405 refers to the reference numerology in an aperiodic configuration configured for the forward operation of the FU 320.

FIG. 5 is a flowchart diagram illustrating an example method 500 for managing forwarding signals by the SN 106, according to various arrangements. The method 500 can be performed by the SN 106. At 510, the first communication node (e.g., the SN 106 or the CU 310) receives from a controller control information. At 520, the first communication node (e.g., the SN 106 or the CU 310) determines a reference time-domain resource (e.g., the reference slot 405) based on at least one of a first time-domain resource or a first offset (e.g., offset k). At 530, the first communication node (e.g., the SN 106 or the CU 310) determines at least one second time-domain resource (e.g., the resources 410 and 420) based on the reference time-domain resource. At 540, the first communication node (e.g., the SN 106 or the FU 320) forwarding, by the first communication node according to the control information using the at least one second time-domain resource, a signal received from a second communication node to a third communication node.

In some arrangements, the first communication node includes at least one of an SN, a repeater, a relay node, an RIS, an IRS, an IAB node, a portion or part of a BS, a TRP, a UE, or a wireless communication device.

In some arrangements, the second communication node includes a BS. The third communication node includes a UE or a wireless communication device. The controller includes at least one of the second communication node or the third communication node.

In some arrangements, the second communication node comprises a UE or a wireless communication device. The third communication node comprises a BS. The controller includes at least one of the second communication node or the third communication node.

In some arrangements, the first time-domain resource includes a time-domain resource in which the first communication node receives a channel or a time-domain resource that overlaps with an end portion of the channel. The channel includes an indication indicating the control information.

In some arrangements, the indication includes at least one of a DCI, UCI, or SCI. In some arrangements, the channel comprises at least one of a PDCCH, a PDSCH, a PUCCH, a PUSCH, a PSSCH, a PSCCH, or a PSFCH. In some arrangements, the first time-domain resource includes a slot or another suitable time-domain unit such as frame or subframe. In some arrangements, the reference time-domain resource includes a slot or another suitable time-domain unit such as frame or subframe.

In some arrangements, the first time-domain resource is determined using a reference numerology, the reference numerology is applied to forwarding the signal. In some arrangements, the first time-domain resource is determined using a numerology of the channel or a BWP in which the channel is located.

In some arrangements, within a time interval between the first time-domain resource and the reference time-domain resource, the method 500 further includes at least one of decoding, by the first communication node, the control information, performing, by the first communication node, beam switching, or performing, by the first communication node, inter-module operation, wherein the time interval corresponds to the first offset.

In some arrangements, the reference time-domain resource is a time-domain resource that is after the first time-domain resource by a number of time-domain resources defined by the first offset. In some arrangements, the reference time-domain resource is a time-domain resource that is offset by a number of time-domain resources defined by the first offset from the first time-domain resource. In some arrangements, the reference time-domain resource has an index n+k_{offset}. k_{offset} is a number of time-domain resources indicated by the first offset. In some examples, n is an index of the first time-domain resource.

In some arrangements, the reference time-domain resource is a time-domain resource that is after the first time-domain resource by a number of time-domain resources defined by one of expression (1) or expression (2).

In some arrangements, the reference time-domain resource is a time-domain resource that is offset by a number of time-domain resources from the first time-domain resource, wherein the first offset is defined by one of expression (1) or expression (2).

In some arrangements, the reference time-domain resource is a time-domain resource having an index defined by one of expression (3) or expression (4).

In some arrangements, a second time-domain resource has a numerology of a channel, and the second time-domain resource is after the first time-domain resource by a number of time-domain resources indicated by the first offset. The reference time-domain resource has a reference numerology and overlaps with the second time-domain resource.

In some arrangements, a second time-domain resource has a numerology of a channel, and the second time-domain resource is offset by a number of slots indicated by the first offset from the first time-domain resource. The reference time-domain resource has a reference numerology and overlaps with the second time-domain resource.

In some arrangements, the reference time-domain resource has an index defined by one of expression (5) or expression (6). In some arrangements, the reference time-domain resource has an index defined by one of expression (7) or expression (8).

In some arrangements, the reference time-domain resource is the first time-domain resource. In some arrangements, the reference time-domain resource is a time-domain resource after the first time-domain resource.

In some arrangements, reference time-domain resource is further defined by adding or interpolating an additional value. In some arrangements, the additional value comprises at least one of a predefined value, a value indicated by the controller, a value determined by a·m, where a includes a coefficient determined based on a numerology of the channel containing the control information or a reference numerology, and m is a predefined value or a value indicated by the controller. In some arrangements, the value determined by a-m is rounded to a nearest integer, rounded up to an integer, or rounded down to an integer.

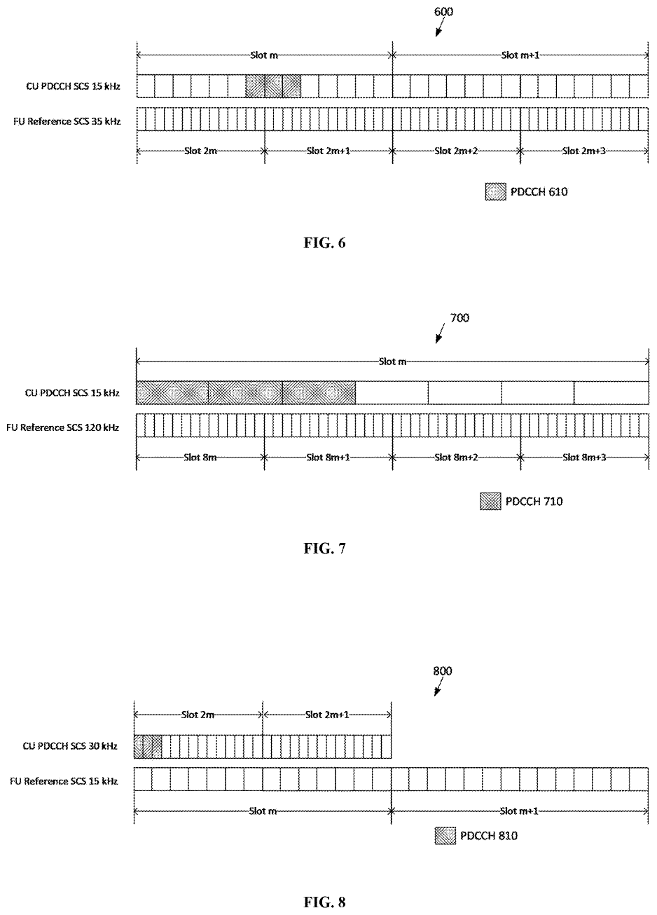

FIG. 6 is a diagram illustrating an example time-domain structure 600 for CU channel SCS of 15 kHz and FU reference SCS of 35 kHz, according to various arrangements. The time-domain structure for CU channel SCS of 15 kHz includes slot m and slot m+1. The time-domain structure for FU reference SCS of 35 kHz includes slot 2m, slot 2m+1, slot 2m+2, and slot 2m+3. As shown, given the SCS, two slots for the FU reference SCS of 35 kHz has a same duration is one slot for the CU channel SCS of 15 kHz. Each block represents a symbol in a slot. The channel (e.g., PDCCH 610) is received in the three symbols by the CU 310 as shown.

FIG. 7 is a diagram illustrating an example time-domain structure 700 for CU channel SCS of 15 kHz and FU reference SCS of 120 kHz, according to various arrangements. The time-domain structure for CU channel SCS of 15 kHz includes slot m. The time-domain structure for FU reference SCS of 120 kHz includes slot 8m, slot 8m+1, slot 8m+2, and slot 8m+3. As shown, given the SCS, four slots for the FU reference SCS of 120 kHz has a same duration is one slot for the CU channel SCS of 15 kHz. Each block represents a symbol in a slot. The channel (e.g., PDCCH 710) is received in the three symbols by the CU 310 as shown.

As shown in FIGS. 6 and 7, the SCS of PDCCH received by the CU 310 can be less than the reference SCS. In the example in which PDCCH SCS is 15 kHz, the reference SCS can be 30 kHz or 120 kHz. In this case, PDCCH can span or occupy several FU slots with reference SCS, especially in out of band scenarios. Thus, in the examples in which slot n is based on the reference numerology, slot n is a slot that overlaps with an end portion of a channel reception.

In some examples, the reference slot 405 is a slot that is after a slot (e.g., slot n) that overlaps with an end of the channel reception that provides the side control indication (e.g., carried in one or more of the DCI, UCI, or SCI) by a number of slots corresponding to or defined by the offset k. That is, the reference slot 405 is a number of slots (indicated or corresponding to the offset k) after a slot that overlaps with a channel containing the side control indication. In some examples, the reference slot 405 is a slot that is offset by a number of slots indicated by or corresponding to offset k from a slot (e.g., slot n) that overlaps with an end portion of a channel providing the side control indication (e.g., carried in one or more of the DCI, UCI, or SCI) is received. That is, the reference slot 405 is offset with respect to the slot (e.g., slot n) that overlaps with the channel providing the side control indication by a number of slots defined by offset k.

In some examples, the reference slot 405 can be defined as slot n+k_{offset}. k_{offset} is a number of slots indicated by offset k. Slot n is at least one slot of the channel reception or a slot that overlaps with the end of the channel reception. In some examples, slot n, slot n+k_{offset} are indexed in a frame. The numerology of slot n, reference slot, or slot n+k_{offset} refers to the reference numerology. k_{offset} is determined based on the reference numerology.

In some arrangements, a numerology of slot n refers to a reference numerology, and the numerology of offset k refers to a numerology of a channel (e.g., PDCCH). That is, although the numerology of slot n refers to the reference numerology, the value of offset k is determined based on the numerology of the channel or active BWP of the CU 310. In some examples, the reference slot 405 cannot be directly determined by slot n and the value of offset k because their numerologies are different. The value of offset k needs to be converted to a new value with the reference numerology first. Then, the reference slot 405 can be acquired based on slot n and the new value of offset k.

In some examples, the reference slot 405 is a slot (or the first slot) that is after at least one slot (e.g., slot n) in which the channel providing side control indication (e.g., carried in one or more of the DCI, UCI, or SCI is received by a number of slots defined by:

$$⌊ \frac{{2}^{{μ}_{ref}}}{{2}^{{μ}_{c hannel}}} \cdot {k}_{offset , {μ}_{c hannel}} ⌋ , \qquad ( 1 )$$

where μ_{ref} is the SCS configuration for the SCS provided by reference numerology, μ_{channel} is the SCS configuration for the channel (e.g., PDCCH), and k_{offset,μ}_{_{channel}} is a number of slots indicated by offset k. In some arrangements, the SCS of the channel can be the same as the SCS of a BWP in which the channel is located. That is, the reference slot 405 is a number of slots after the at least one slot in which the side control indication is received, the number of slots determined using expression (1) (based on the SCS configuration and the offset k).

In some examples, the reference slot 405 is a slot that is offset by a number of slots determined using expression (1) from at least one slot (e.g., slot n) in which channel providing the side control indication (e.g., carried in one or more of the DCI, UCI, or SCI) is received. That is, the reference slot 405 is offset with respect to the at least one slot (e.g., slot n) in which channel providing the side control indication by a number of slots determined using expression (1) (based on the SCS configuration and the offset k).

In some examples, the reference slot 405 is a slot that is after a slot (e.g., slot n) that overlaps with an end of the channel reception that provides the side control indication (e.g., carried in one or more of the DCI, UCI, or SCI) by a number of slots determined using expression (1). That is, the reference slot 405 is a number of slots (determined using expression (1)) after a slot that overlaps with a channel containing the side control indication.

In some examples, the reference slot 405 is a slot that is offset by a number of slots determined using expression (1) from a slot (e.g., slot n) that overlaps with an end portion of a channel providing the side control indication (e.g., carried in one or more of the DCI, UCI, or SCI) is received. That is, the reference slot 405 is offset with respect to the slot (e.g., slot n) that overlaps with the channel providing the side control indication by a number of slots determined using expression (1).

In some arrangements, the indication carried by the one or more of the DCI, UCI, or SCI is used to indicate the control information for the forward operation or the amplify-and-forward operation of the FU 320 (e.g., the information of beam or time-domain resource in access link). I some arrangements, the reference slot 405 is used as the reference for the time-domain resource configured for the forward operation or the amplify-and-forward operation of the FU 320, and the numerology of reference slot 405 refers to the reference numerology in an aperiodic configuration configured for the forward operation of the FU 320.

In some arrangements, the numerology of the slot where PDCCH receives or ends refers to the reference numerology. As shown in FIGS. 6 and 7, the SCS of PDCCH received by the CU 310 can be less than reference SCS. In the example in which the PDCCH SCS is 15 kHz, the reference SCS is 30 kHz or 120 kHz. A PDCCH may span or occupy several FU slots with reference SCS, especially in out of band scenarios.

In some arrangements, the numerology of the number of slots indicated by offset k refers to the numerology of PDCCH or the active BWP of the CU 310. The number needs to be converted to the number of slots based on the reference SCS.

FIG. 8 is a diagram illustrating an example time-domain structure 800 for CU channel SCS of 30 kHz and FU reference SCS of 15 kHz, according to various arrangements. The time-domain structure for CU channel SCS of 30 kHz includes slots 2m and 2m+1. The time-domain structure for FU reference SCS of 15 kHz includes slot m and slot m+1. As shown, given the SCS, two slots for the CU reference SCS of 30 kHz has a same duration is one slot for the FU channel SCS of 15 kHz. Each block represents a symbol in a slot. The channel (e.g., PDCCH 810) is received in the three symbols by the CU 310 as shown.

As shown in FIG. 8, the SCS of PDCCH 810 (e.g., 30 kHz) received by the CU 310 can be greater than the reference SCS, which is 15 kHz. In some examples in which the value of Offset k_{slot offset,μ}_{_{channel}} is equal to an odd number (e.g., 1), the value determined using expression (1) is less than the actual required delay for DCI decoding, beam switching, and/or inter-module operation. In some examples,

$$\frac{{2}^{{μ}_{ref}}}{{2}^{{μ}_{c hannel}}} \cdot {k}_{offset , {μ}_{c hannel}}$$

can be rounded to or rounded up to a closest integer or

$$⌈ \frac{{2}^{{μ}_{ref}}}{{2}^{{μ}_{c hannel}}} \cdot {k}_{offset , {μ}_{c hannel}} ⌉ . \qquad ( 2 )$$

In some examples,

$$\frac{{2}^{μ} ref}{{2}^{μ} channel} \cdot {k}_{offset , {μ}_{channel}}$$

can be neither rounded up nor down if decimal number of slots is supported.

In some examples, the reference slot 405 is a slot (or the first slot) that is after at least one slot (e.g., slot n) in which the channel providing side control indication (e.g., carried in one or more of the DCI, UCI, or SCI is received by a number of slots defined by expression (2). That is, the reference slot 405 is a number of slots after the at least one slot in which the side control indication is received, the number of slots determined using expression (2) (based on the SCS configuration and the offset k).

In some examples, the reference slot 405 is a slot that is offset by a number of slots determined using expression (2) from at least one slot (e.g., slot n) in which channel providing the side control indication (e.g., carried in one or more of the DCI, UCI, or SCI) is received. That is, the reference slot 405 is offset with respect to the at least one slot (e.g., slot n) in which channel providing the side control indication by a number of slots determined using expression (2) (based on the SCS configuration and the offset k).

In some examples, the reference slot 405 is a slot that is after a slot (e.g., slot n) that overlaps with an end of the channel reception that provides the side control indication (e.g., carried in one or more of the DCI, UCI, or SCI) by a number of slots determined using expression (2). That is, the reference slot 405 is a number of slots (determined using expression (2)) after a slot that overlaps with a channel containing the side control indication.

In some examples, the reference slot 405 is a slot that is offset by a number of slots determined using expression (2) from a slot (e.g., slot n) that overlaps with an end portion of a channel providing the side control indication (e.g., carried in one or more of the DCI, UCI, or SCI) is received. That is, the reference slot 405 is offset with respect to the slot (e.g., slot n) that overlaps with the channel providing the side control indication by a number of slots determined using expression (2).

In some examples, the reference slot 405 is a

$$slot n + ⌊ \frac{{2}^{μ} ref}{{2}^{μ} channel} \cdot {k}_{offset , {μ}_{channel}} ⌋ , or slot$$

$$n + ⌈ \frac{{2}^{{μ}_{ref}}}{{2}^{{μ}_{c hannel}}} \cdot {k}_{offset , {μ}_{c hannel}} ⌉ ,$$

where μ_{ref} is the SCS configuration for the SCS provided by reference numerology, μ_{channel} is the SCS configuration for the channel (e.g., PDCCH), and k_{offset,μ}_{_{channel}} is a number of slots indicated by offset k. In other words, the reference slot 405 can be defined by an index determined using one of:

$$n + ⌊ \frac{{2}^{μ} ref}{{2}^{μ} channel} \cdot {k}_{offset , {μ}_{channel}} ⌋ ; \qquad ( 3 )$$

$$or$$

$$n + ⌈ \frac{{2}^{μ} ref}{{2}^{μ} channel} \cdot {k}_{offset , {μ}_{channel}} ⌉ . \qquad ( 4 )$$

Slot n is a slot of the channel reception or a slot that overlaps with the end of the channel reception. For example, one or more of slot n, slot n

$$slot n + ⌊ \frac{{2}^{μ} ref}{{2}^{μ} channel} \cdot ( n + {k}_{offset , {μ}_{channel}} ) ⌋ , or slot$$

$$n + ⌈ \frac{{2}^{{μ}_{ref}}}{{2}^{{μ}_{c hannel}}} \cdot {k}_{offset , {μ}_{c hannel}} ⌉$$

are indexed in a frame. The numerology of slot n refers to the reference numerology. The numerology of one or more of reference slot 405,

$$slot n + ⌊ \frac{{2}^{μ} ref}{{2}^{μ} channel} \cdot {k}_{offset , {μ}_{channel}} ⌋ , or slot n + ⌈ \frac{{2}^{{μ}_{ref}}}{{2}^{{μ}_{c hannel}}} \cdot {k}_{offset , {μ}_{c hannel}} ⌉$$

refers to the reference numerology. In some examples, k_{offset,μ}_{_{ref}} is determined based on the numerology of the channel e.g., PDCCH.

In some arrangements, both a numerology of slot n and offset k refer to a numerology of a channel (e.g., PDCCH). For example, the numerology of slot n refers to the numerology of the channel e.g., PDCCH or active BWP of the CU 310, and the value of offset k is also determined based on the numerology of the channel or active BWP of the CU 310. Then, slot n+k with the numerology of the channel can be acquired based on slot n and the value of offset k. After that, the reference slot 405 with the reference numerology can be determined based on slot n+k with the numerology of the channel.

In some examples, slot x (e.g., x=n+k) is a slot with the numerology of the channel, the slot is after slot n of the channel reception that provides the side control indication (e.g., carried in one or more of the DCI, UCI, or SCI) by a number of slots indicated by offset k. The reference slot 405 is a slot (or the first slot) with the reference numerology that overlaps with slot x.

In some examples, slot x (e.g., x=n+k) is a slot with the numerology of the channel, the slot is offset by a number of slots indicated by offset k from slot n of the channel reception that the side control indication (e.g., carried in one or more of the DCI, UCI, or SCI). The reference slot 405 is a slot (or the first slot) with the reference numerology that overlaps with slot x.

In some examples, the indication carried by the one or more of the DCI, UCI, or SCI is used to indicate the control information for forward operation of the FU 320 (e.g., the information of beam or time-domain resource in access link). In some examples in which the reference slot 405 is used as the reference for the time-domain resource configured for the forward operation of the FU 320, the numerology of reference slot 405 refers to the reference numerology in an aperiodic configuration configured for the forward operation of the FU 320.

In some examples, as shown in FIGS. 6 and 7, the SCS of the PDCCH 610 or 710 received by the CU 310 can be less than reference SCS. In the examples in which PDCCH SCS is 15 kHz, the reference SCS is 30 kHz or 120 kHz. Slot n+k (e.g., slot x) with the SCS of PDCCH 610 or 710 can map to several slots with the reference SCS. In some examples, the reference slot 405 can be the first slot with the reference SCS that overlaps with slot n+k. In some examples, the reference slot 405 can also be the last or another specified slot with the reference SCS that overlaps with slot n+k.

In some examples, as shown in FIG. 8, the SCS of PDCCH 610 or 710 received by the CU 310 can be greater than the reference SCS. In the examples in which the PDCCH SCS is 30 kHz, the reference SCS is 15 kHz. If the value of offset k is equal to an odd number (e.g., 1), the spacing between the PDCCH and the reference slot 405 defined can be less than an actual required delay for DCI decoding, beam switching, and/or inter-module operation. In this case, the reference slot 405 can be delayed to a next slot or a following slot.

In some examples, the reference slot 405 is slot having an index defined by one of:

$$⌈ \frac{{2}^{μ} ref}{{2}^{μ} channel} \cdot ( n + {k}_{offset , {μ}_{channel}} ) ⌉ ; \qquad ( 5 )$$

$$or$$

$$⌊ \frac{{2}^{μ} ref}{{2}^{μ} channel} \cdot ( n + {k}_{offset , {μ}_{channel}} ) ⌋ , \qquad ( 6 )$$

where μ_{ref} is the SCS configuration for the SCS provided by reference numerology, μ_{channel} is the SCS configuration for the channel (e.g., PDCCH), and k_{offset,μ}_{_{channel}} is a number of slots indicated by offset k. Slot n is a slot of the channel reception that provides the one or more of the DCI, UCI, or SCI carrying the indication.

In some examples, one or more of slot n,

$$slot ⌈ \frac{{2}^{μ} ref}{{2}^{μ} channel} \cdot ( n + {k}_{offset , {μ}_{c hannel}} ) ⌉ , or slot$$

$$⌊ \frac{{2}^{μ} ref}{{2}^{μ} channel} \cdot ( n + {k}_{offset , {μ}_{c hannel}} ) ⌋$$

are indexed in a frame. In some examples, the numerology of slot n refers to the numerology of the channel e.g., PDCCH (or active BWP of the CU 310). In some examples, the numerology of reference slot 405,

$$slot ⌈ \frac{{2}^{μ} ref}{{2}^{μ} channel} \cdot ( n + {k}_{offset , {μ}_{c hannel}} ) ⌉ or$$

$$⌊ \frac{{2}^{μ} ref}{{2}^{μ} channel} \cdot ( n + {k}_{offset , {μ}_{c hannel}} ) ⌋$$

refers to the reference numerology. In some examples, k_{offset,μ}_{_{ref}} is determined based on the numerology of the channel e.g., PDCCH.

In some examples, slot x (e.g., slot n+k) is a slot defined herein. The reference slot 405 is the first slot that overlaps with slot x, or the first complete slot after the starting boundary of slot x.

In some arrangements, a numerology of slot n refers to a numerology of a channel (e.g., PDCCH), and the numerology of offset k refers to a reference numerology. Although the numerology of slot n refers to the numerology of the channel (or active BWP of the CU 310), but the value of offset k is determined based on the reference numerology. Thus the reference slot 405 cannot be directly determined by slot n and the value of offset k because their numerologies are different.

In some examples, the reference slot 405 is slot having an index defined by one of.

$$⌈ \frac{{2}^{μ} ref}{{2}^{μ} channel} \cdot n ⌉ + {k}_{offset , {μ}_{ref}} ; \qquad ( 7 )$$

$$or$$

$$⌈ \frac{{2}^{μ} ref}{{2}^{μ} channel} \cdot n ⌉ + {k}_{offset , {μ}_{ref}} , \qquad ( 8 )$$

where μ_{ref} is the SCS configuration for the SCS provided by reference numerology, μ_{channel} is the SCS configuration for the channel (e.g., PDCCH), and k_{slot offset,μ}_{_{ref}} is a number of slots indicated by offset k. Slot n is a slot of the channel reception that provides the one or more of the DCI, UCI, or SCI carrying the indication.

In some examples, one or more of slot n,

$$slot ⌈ \frac{{2}^{µ} ref}{{2}^{µ} channel} \cdot n ⌉ + {k}_{offset , {µ}_{ref}} , or slot$$

are indexed in a frame. In some examples, the numerology of slot n refers to the numerology of the channel e.g., PDCCH (or active BWP of the CU 310). In some examples, the numerology of reference slot 405,

$$slot ⌈ \frac{{2}^{µ} ref}{{2}^{µ} channel} \cdot n ⌉ + {k}_{offset , {µ}_{ref}} , or slot$$

refers to the reference numerology. In some examples, the k_{offset,μ}_{_{ref}} is determined based on the reference numerology.

In some arrangements, the reference slot 405 can be determined using an additional value. The value can be used to address the spacing between the channel reception and the reference slot being less than the needed delay for channel decoding and beam switching (e.g., offset k). For example, the reference slot 405 a reference slot determined in the manner described herein plus one additional value. In the example in which the reference slot 405 determined using any of the aforementioned examples is referred to as slot y, the additional value is M, then the reference slot 405 can have an index equal to slot y+M.

For example, the reference slot 405 is slot n+k_{offset}+M. For example, k_{slot offset} is a number of slots indicated by offset k. Slot n is at least one slot of the channel reception or a slot that overlaps with the end of the channel reception.

For another example, the reference slot 405 is

$$slot n + ⌊ \frac{{2}^{µ} ref}{{2}^{µ} channel} \cdot {k}_{slot offset , {µ}_{channel}} ⌋ + M or slot n + ⌈ \frac{{2}^{µ} ref}{{2}^{µ} channel} \cdot {k}_{offset , {µ}_{channel}} ⌉ + M .$$

For example, μ_{ref} is the SCS configuration for the SCS provided by reference numerology, μ_{channel} is the SCS configuration for the channel (e.g. PDCCH), and k_{offset,μ}_{_{channel}} is a number of slots indicated by offset k. Slot n is a slot of the channel reception or a slot that overlaps with the end of the channel reception.

For another example, the reference slot is

$$slot ⌈ \frac{{2}^{µ} ref}{{2}^{µ} channel} \cdot ( n + {k}_{offset , {µ}_{channel}} ) ⌉ + M or slot ⌊ \frac{{2}^{µ} ref}{{2}^{µ} channel} \cdot ( n + {k}_{offset , {µ}_{channel}} ) ⌋ + M .$$

For example, μ_{ref} is the SCS configuration for the SCS provided by reference numerology, μ_{channel} is the SCS configuration for the channel (e.g., PDCCH), and k_{offset,μ}_{_{channel}} is a number of slots indicated by offset k. Slot n is a slot of the channel reception that provides one or more of the DCI, UCI, or SCI carrying the indication.

For another example, the reference slot is

$$slot ⌈ \frac{{2}^{µ} ref}{{2}^{µ} channel} \cdot n ⌉ + {k}_{offset , {µ}_{ref}} + M or slot ⌊ \frac{{2}^{µ} ref}{{2}^{µ} channel} \cdot n ⌋ + {k}_{offset , {µ}_{ref}} + M .$$

For example, μ_{ref} is the SCS configuration for the SCS provided by reference numerology, μ_{channel} is the SCS configuration for the channel (e.g., PDCCH), and k_{offset,μ}_{_{ref}} is a number of slots indicated by offset k. Slot n is a slot of the channel reception that provides one or more of the DCI, UCI, or SCI carrying the indication.

In some examples, the additional value M can be a predefined value, such as 1, 2, and so on. In some examples, the additional value M can be a value indicated by the controller (e.g., the BS 102 or the UE 104). For example, the BS indicates the value M in the signaling of aperiodic configuration. In some examples, the additional value M can be defined by a·m, where a is a coefficient depending on the numerology of the channel and/or the reference numerology, e.g.,

$$a = \frac{{2}^{µ} ref}{{2}^{µ} channel} ,$$

a=2^{μ}^{_{ref}} or a=2^{μ}^{_{channel}}. m is a predefined value, a value indicated by the controller (e.g., the BS 102 or the UE 104), m=0 if m is not indicated. In some examples, a·m can also be rounded to the nearest integer, rounded up to an integer, or rounded down to an integer. For example, the controller can indicate the value m in the signaling of aperiodic configuration.

In some arrangements, the reference slot 405 can be obtained by interpolating a value into a method, expression, or formula for the reference slot 405 determined according to various arrangement disclosed herein, or by interpolating a value into the process of deriving the reference slot 405 according to various arrangements disclosed herein. The value can be used to address the spacing between the end of the channel reception and the reference slot being less than the delay needed for channel decoding and beam switching.

For an additional value denoted as M, in some examples, the reference slot 405 is

$$slot n + ⌊ \frac{{2}^{µ} ref}{{2}^{µ} channel} \cdot ( {k}_{offset , {µ}_{channel}} + M ) ⌋ or slot n + ⌈ \frac{{2}^{µ} ref}{{2}^{µ} channel} \cdot ( {k}_{offset , {µ}_{channel}} + M ) ⌉ .$$

For an additional value denoted as M, the reference slot 405 is

$$slot ⌈ \frac{{2}^{µ} ref}{{2}^{µ} channel} \cdot ( n + {k}_{offset , {µ}_{channel}} + M ) ⌉ or slot ⌊ \frac{{2}^{µ} ref}{{2}^{µ} channel} \cdot ( n + {k}_{offset , {µ}_{channel}} + M ) ⌋ .$$

For an additional value denoted as M, the reference slot 405 is

$$slot ⌈ \frac{{2}^{µ} ref}{{2}^{µ} channel} \cdot ( n + M ) ⌉ + {k}_{offset , {µ}_{ref}} or slot ⌊ \frac{{2}^{µ} ref}{{2}^{µ} channel} \cdot ( n + M ) ⌋ + {k}_{offset , {µ}_{ref}} .$$

In some examples, the value of M can be any value as described herein. In some examples, the value of M is a predefined value, such as 1 or 2. In some examples, the value of M is indicated by the controller. For example, the controller can indicate the value M in the signaling of aperiodic configuration. In some examples, M can be defined by a·m, where a is a coefficient depending on the numerology of the channel and/or the reference numerology, e.g.,

$$a = \frac{{2}^{µ} ref}{{2}^{µ} channel} ,$$

a=2^{μ}^{_{ref}}, or a=2^{μ}^{_{channel}}. m is a predefined value, a value indicated by the controller, or m=0 if m is not indicated. In some examples, a·m can also be rounded, rounded up, or rounded down to a closest integer. For example, the controller indicates the value m in the signaling of aperiodic configuration.

In some arrangements, the reference slot 405 is a slot of the channel reception that provides the one or more of the DCI, UCI, or SCI carrying the indication. In some arrangements, the reference slot 405 is a slot (or the first slot) that is after a slot of the channel reception that provides the one or more of the DCI, UCI, or SCI carrying the indication. In some arrangements, the reference slot 405 is a slot that overlaps with the end of the channel reception that provides the one or more of the DCI, UCI, or SCI carrying the indication. In some arrangements, the reference slot 405 is a slot (or the first slot) that is after a slot that overlaps with the end of the channel reception that provides the one or more of the DCI, UCI, or SCI carrying the indication.

In some arrangements, the reference slot 405 is the reference of slot offset for each time resource in the aperiodic configuration. In some arrangements, the stations 102 needs to ensure that the spacing between the starting point of time resources in the aperiodic configuration and the location of the channel (e.g., the slot of PDCCH reception, or the end of PDCCH reception) is no less than offset k. In other words, the SN 106 (e.g., CU 310) can assume that the spacing between the starting point of time resources in the aperiodic configuration and the location of the channel (e.g., the slot of PDCCH reception, or the end of PDCCH reception) is no less than offset k. In some examples, the starting point of at least one time-domain resource (e.g., the resources 410 and 420) starts at a slot that is offset by a first number (e.g., A) slots (e.g., the offsets 415 and 425, respectively) from the reference slot 405 and/or at a symbol that is offset by a second number (e.g., B) symbols (e.g., the offsets 415 and 425, respectively) from the start of the reference slot 405. A and B are slot offset and symbol offset respectively, which are configured by the controller (e.g., the BS 102) to the SN 106 via one or more of RRC, MAC, or DCI signaling.

Some arrangements relate to the application time of the indicated information in the semi-persistent beam indication. In some arrangements, the SN 106 uses or stops using the set of resources configured for SN forwarding starting from a time resource that is after

$$slot k + 3 {N}_{slot}^{subframe , µ} ,$$

where k is the slot where the SN CU would transmit a PUCCH with Hybrid Automatic Repeat Request Acknowledgement (HARQ-ACK) information associated with the PDSCH providing the MAC CE command and μ is the SCS configuration for the PUCCH transmission.

The time resource can be at least one of: a) the first slot, where the numerology (SCS and/or CP) of the first slot is same as the PUCCH transmission; b) the first slot, where the numerology (SCS and/or CP) of the first slot is same as the reference numerology configured for SN forwarding; or c) the first complete slot, where the numerology (SCS and/or CP) of the first slot is same as the reference numerology configured for SN forwarding.

In some arrangements, the SN 106 uses or stops using the set of resources configured for SN forwarding starting from a time point that is after the end of

$$slot k + 3 {N}_{slot}^{subframe , µ} ,$$

where k is the slot where the SN CU would transmit a PUCCH with HARQ-ACK information associated with the PDSCH providing the MAC CE command and y is the SCS configuration for the PUCCH transmission.

In some arrangements, the SN 106 uses or stops using the set of resources configured for SN forwarding starting from a time point that is after

$$slot k + 3 {N}_{slot}^{subframe , µ}$$

where k is the slot where the SN CU would transmit a PUCCH with HARQ-ACK information associated with the PDSCH providing the MAC CE command and y is the SCS configuration for the PUCCH transmission.

While various arrangements of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one arrangement can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method comprising:
receiving, by a first communication node from a Base Station (BS), a Physical Downlink Control Channel (PDCCH) carrying a Downlink Control Information (DCI) indicating control information;
determining, by the first communication node, a reference time-domain resource with a reference numerology based on a first time-domain resource and a first offset with a numerology of the PDCCH, wherein the first time-domain resource comprises a time-domain resource in which the first communication node receives the PDCCH;
determining at least one second time-domain resource based on the reference time-domain resource; and
forwarding, by the first communication node according to the control information using the at least one second time-domain resource, a first signal received from the BS to a User Equipment (UE), or
receiving, by the first communication node according to the control information using the at least one second time-domain resource, a second signal from the UE.

2. The method of claim 1, wherein the reference time-domain resource is a slot with the reference numerology which overlaps with an intermediate slot or is a slot after a starting boundary of the intermediate slot, wherein the intermediate slot is after the first time-domain resource by a number of slots indicated by the first offset, and wherein the first time-domain resource is a slot in which the first communication node receives the PDCCH.

3. The method of claim 2, wherein the numerology of the PDCCH is a Subcarrier Spacing (SCS) of the PDCCH and the reference numerology is a reference SCS.

4. The method of claim 2, wherein
the slot with the reference numerology which overlaps with an intermediate slot is the first slot with the reference numerology which overlaps with an intermediate slot, or
the slot after a starting boundary of the intermediate slot is the first slot after a starting boundary of the intermediate slot.

5. The method of claim 1, wherein the control information comprises the information of at least one beam and time-domain resource in access link.

6. The method of claim 1, wherein
the reference time-domain resource is a first slot with a reference numerology that starts no earlier than a start of a slot that is after a slot of a PDCCH reception by a number of slots indicated by the first offset.

7. The method of claim 1, wherein
the reference time-domain resource has an index defined by:
$$⌈ \frac{{2}^{µ} ref}{{2}^{µ} channel} \cdot ( n + {{k}_{offset , µ}}_{channel} ) ⌉$$
μ_{ref} is SCS configuration for an SCS provided by a reference numerology, μ_{channel} is SCS configuration for channel carrying the control information, k_{offset,μ}_{_{channel}} is a number of time-domain resources indicated by the first offset, and n is an index of the first time-domain resource.

8. The method of claim 1, wherein the reference time-domain resource is used as a reference for the at least one second time-domain resource configured for forwarding operation.

9. The method of claim 1, wherein the PDCCH has an SCS greater than a reference SCS, and the reference time-domain resource is a slot with the reference SCS that overlaps with a slot corresponding to n+k, wherein n is an index of a slot in which the first communication node receives the PDCCH and k is a number of slots indicated by the first offset.

10. The method of claim 1, wherein the reference time-domain resource is further defined by adding an additional value M, wherein M is used when a spacing between a channel reception and the reference time-domain resource is less than a delay for channel decoding and beam switching.

11. A first communication node, comprising:
at least one processor configured to:
receive, via a transceiver from a Base Station (BS), a Physical Downlink Control Channel (PDCCH) carrying a Downlink Control Information (DCI) indicating control information;
determine a reference time-domain resource with a reference numerology based on a first time-domain resource and a first offset with a numerology of the PDCCH, wherein the first time-domain resource comprises a time-domain resource in which the first communication node receives the PDCCH;
determine at least one second time-domain resource based on the reference time-domain resource; and
forward, via the transceiver according to the control information using the at least one second time-domain resource, a first signal received from the BS to a User Equipment, UE, or
receive, via the transceiver according to the control information using the at least one second time-domain resource, a second signal from the UE.

12. The first communication node of claim 11, wherein the reference time-domain resource is a slot with the reference numerology which overlaps with an intermediate slot or is a slot after a starting boundary of the intermediate slot, wherein the intermediate slot is after the first time-domain resource by a number of slots indicated by the first offset, and wherein the first time-domain resource is a slot in which the first communication node receives the PDCCH.

13. The first communication node of claim 12, wherein the numerology of the PDCCH is a Subcarrier Spacing, SCS, of the PDCCH and the reference numerology is a reference SCS.

14. The first communication node of claim 12, wherein
the slot with the reference numerology which overlaps with an intermediate slot is the first slot with the reference numerology which overlaps with an intermediate slot, or
the slot after a starting boundary of the intermediate slot is the first slot after a starting boundary of the intermediate slot.

15. The first communication node of claim 11, wherein the control information comprises the information of at least one beam and time-domain resource in access link.

16. The first communication node of claim 11, wherein the reference time-domain resource is a first slot with a reference numerology that starts no earlier than a start of a slot that is after a slot of a PDCCH reception by a number of slots indicated by the first offset.

17. The first communication node of claim 11, wherein
the reference time-domain resource has an index defined by:
$$⌈ \frac{{2}^{µ} ref}{{2}^{µ} channel} \cdot ( n + {{k}_{offset , µ}}_{channel} ) ⌉$$
μ_{ref} is SCS configuration for an SCS provided by a reference numerology, μ_{channel} is SCS configuration for channel carrying the control information, k_{offset,μ}_{_{channel}} is a number of time-domain resources indicated by the first offset, and n is an index of the first time-domain resource.

18. The first communication node of claim 11, wherein the reference time-domain resource is used as a reference for the at least one second time-domain resource configured for forwarding operation.

19. The first communication node of claim 11, wherein the PDCCH has an SCS greater than a reference SCS, and the reference time-domain resource is a slot with the reference SCS that overlaps with a slot corresponding to n+k, wherein n is an index of a slot in which the first communication node receives the PDCCH and k is a number of slots indicated by the first offset.

20. The first communication node of claim 11, wherein the reference time-domain resource is further defined by adding an additional value M, wherein M is used when a spacing between a channel reception and the reference time-domain resource is less than a delay for channel decoding and beam switching.
